(19) United States
(12) Patent Application Publication
(10) Pub. No.: US 2016/0211047 A1
(43) Pub. Date: Jul. 21, 2016

(54) LED INK CURING APPARATUS

(71) Applicant: GEW (EC) LIMITED, CRAWLEY (GB)

(72) Inventors: MALCOLM RAE, CRAWLEY (GB); JAMES HICKS, CRAWLEY (GB); ROBERT RAE, CRAWLEY (GB)

(21) Appl. No.: 15/001,940

(22) Filed: Jan. 20, 2016

(30) Foreign Application Priority Data
Jan. 20, 2015 (GB) 1500938.4

(51) Int. Cl. G21K 5/00; F21V 29/89; F21V 29/60; F21V 29/70; F21V 29/58

(52) U.S. Cl. CPC G21K 5/00; F21V 29/70; F21V 29/59; F21V 29/60; F21V 29/89; F21Y 2101/02

(57) ABSTRACT

A print curing apparatus (1) comprising one or more LED modules (3) wherein each LED module (3) comprises at least one LED (5) and wherein the or each LED module (3) is mounted on a heat sink (4); and a cooling system (19) comprising one or more fluid jets (29) wherein the or each fluid jet (29) is directed towards the or each heat sink (4).

### FIELD OF THE INVENTION

The present invention relates to a print curing apparatus, having an LED array.

### BACKGROUND OF THE INVENTION

The use of ultra violet (UV) LED (light-emitting diode) arrays for ink curing is becoming increasingly popular as an alternative to traditional mercury arc UV lamps. The ink curing apparatus must be cooled effectively to reduce the risk of apparatus failure and also to reduce any safety risks associated with overheating of the apparatus. Effective cooling of LED print curing apparatus also ensures maximum efficiency of print curing, whilst minimising the cost and environmental impact of the use of the print curing apparatus. Furthermore, effective cooling ensures that the lifetime of the valuable LED units is as long as possible and reduces the time, cost and inconvenience of maintenance of the apparatus. Inefficient cooling of the LEDs significantly reduces the lifetime of the LEDs.

Patent publications US 2008/151029 and WO 2010/105365 disclose the use of fans to draw air away from a heat sink provided in a UV LED array and so to remove heat generated. It is also known to use water/liquid cooling of a UV LED array by having a closed pipe/s through which liquid continuously flows past, along or through a heat sink and so to carry heat away. However, it has been found that existing cooling methods are problematic because the cooling achieved is not sufficiently effective nor is cooling uniform along the length of the apparatus. Thus, the efficiency of the print curing varies along the length of the apparatus to the detriment of the quality of curing along the substrate to be cured.

### SUMMARY OF THE INVENTION

The present invention sets out to provide an improved UV ink curing apparatus, which alleviates the problems described above.

In one aspect, the invention provides a print curing apparatus comprising:

one or more LED modules wherein each LED module comprises at least one LED and wherein the or each LED module is mounted on a heat sink; and

a cooling system comprising one or more fluid jets wherein the or each fluid jet is directed towards the or each heat sink.

It has been found that having a fluid jet “directed towards” the or each heat sink significantly improves the cooling of an LED print curing apparatus. Furthermore, by using jets that are directed the flow and pressure of the fluid, such as water, onto the heat sink can be carefully controlled to achieve highly efficient transfer of heat from the heat sink and also cooling uniformity along the length of the print curing apparatus. The present invention provides cooling that is length independent, wherein the length of the apparatus is understood to be the longest dimension of the apparatus. The present applicant has found that the flow rates that would be required by existing “flow past” devices to achieve the cooling effect of the present invention would be significantly greater than those required by the present invention.

It is understood that the “jet” of the present invention is a forceful stream of fluid discharged from a narrow aperture and is “directed towards” the heat sink; that is, the fluid jet is caused to move in a particular, controlled way. The fluid jet “directed towards” the heat sink is controlled to achieve the desired cooling effect; for example, any one or more of the speed, direction, volume, pressure and/or shape of the fluid jet is regulated/aimed to achieve the highly efficient and uniform cooling.

Preferably, the or each fluid jet is expelled from an aperture and/or a nozzle.

Preferably, the aperture and/or nozzle is spaced from the heat sink.

Preferably, the fluid is air or water.

Preferably, the or each fluid jet has a diameter of between about 0.5 mm and about 5 mm; preferably between about 1.0 mm and about 4 mm; preferably, between about 1 mm and about 3 mm.

Preferably, the or each fluid jet enters the cooling system through an aperture.

Preferably, the cooling system comprises a plurality of fluid jets, wherein each fluid jet is directed towards the or each heat sink.

More preferably, each fluid jet is directed towards the or each sink in a direction substantially perpendicular to the planar surface/s of the or each heat sink.

Preferably, the cooling system comprises a plurality of fluid jets spaced at a pre-determined distance from each other along the length of the or each heat sink.

Preferably, the cooling system comprises a plurality of equally spaced fluid jets directing fluid substantially perpendicular to the planar surface/s of the or each heat sink.

Preferably, the spacing between the aperture or nozzle through which the or each fluid jet is directed and the adjacent aperture or nozzle is between about 1 mm and about 7 mm; more preferably, the spacing is between about 3 mm and about 5 mm.

It has been found that careful control of the spacing between the apertures/nozzles ensures that the fluid jets directed therethrough have sufficient speed to create a turbulent flow when they hit the heat sink. The turbulent flow is controlled along the length of the apparatus to ensure that the cooling is uniform.

It is envisaged that the spacing of the fluid jets can be pre-determined according to the heat profile along the heat sink—i.e. along the longer dimension of the heat sink/s and/or the print curing apparatus, and also across the heat sink—i.e. along the shorter dimension of the heat sink/s and/or the print curing apparatus. This enables the temperature of the heat sink to be carefully controlled to achieve uniform cooling.

Preferably, the or each aperture has a diameter of between about 0.5 mm and about 5 mm; preferably, the or each aperture has a diameter of between about 1 mm and about 5 mm; preferably, the or each aperture has a diameter of between about 2 mm and about 5 mm.

Preferably, the or each aperture is positioned along the longitudinal midline of the heat sink.

Preferably, the pressure difference between the fluid behind the aperture and the fluid in front of the aperture is between about 0.1 Bar and about 0.5 Bar; preferably, the pressure difference between the fluid behind the aperture and the fluid in front of the aperture is between about 0.2 Bar and about 0.4 Bar; more preferably, the pressure difference between the fluid behind the aperture and the fluid in front of the aperture is between at least about 0.3 Bar.

Preferably, the or each heat sink comprises a metal plate; more preferably a copper plate.

Preferably, the or each heat sink comprises a copper plate supported by a plastic or aluminium support member.

The heat sink of the present invention transfers heat quickly and effectively from the apparatus.

Preferably, the flow of fluid around the cooling system is turbulent.

Preferably, the flow of fluid around the cooling system is at a rate of between about 0.25 L/min and about 10.0 L/min per 2.5 cm width of an array comprising one or more LED modules.

Preferably the flow of fluid around the cooling system is at a rate of about 0.1 L/min to about 5.0 L/min per cm width of an array comprising one or more LED modules.

For the purposes of clarity and a concise description, features are described herein as part of the same or separate embodiments; however it will be appreciated that the scope of the invention may include embodiments having combinations of all or some of the features described.

### BRIEF DESCRIPTION OF THE DRAWINGS

The invention will now be described by way of example with reference to the accompanying drawings, in which:—

FIG. 1 is a cross-sectional view through a UV ink curing apparatus constructed according to the present invention;

FIG. 2 is a schematic view from above of multiple LED modules arranged in a LED print curing apparatus, showing the apertures through which cooling fluid is directed to carry heat away from a heat sink;

FIG. 3 is an enlarged view of the area marked C in FIG. 2;

FIG. 4 illustrates alternative embodiments of the present invention, showing the apertures through which cooling fluid is directed to carry heat away from a heat sink;

FIG. 5 is a graph of temperature above a reference point (° C.) against distance across a LED array (mm); and

FIG. 6 is a schematic illustration showing how a fluid jet is controlled according to the present invention.

The present invention relates to a UV print curing apparatus and within this specification, the term “LED module” means a unit containing one or more LEDs that is supplied as a radiation source.

### DETAILED DESCRIPTION

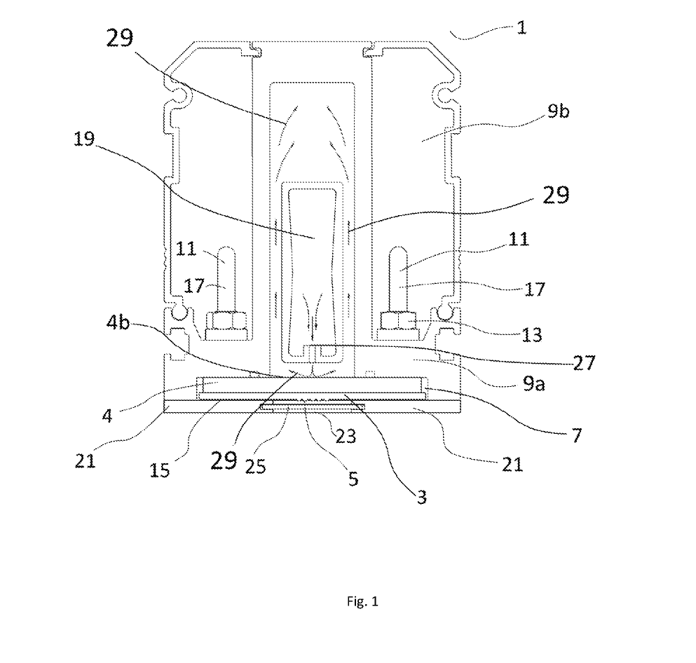

Referring to FIG. 1, there is shown a UV print curing apparatus 1 comprising a plurality of LED modules 3. Each LED module 3 comprises a plurality of LEDs 5. A heat sink 4 is provided adjacent to a LED mounting area 7. The heat sink 4 is a copper plate insert supported by a plastic or aluminium plate or frame. The heat sink 4 is provided above the LED modules 3; that is, on the opposing face of the mounting area 7 to the substrate (not shown). The copper plate insert of the heat sink 4 is used to increase the conductivity of heat carried away from the LED modules 3.

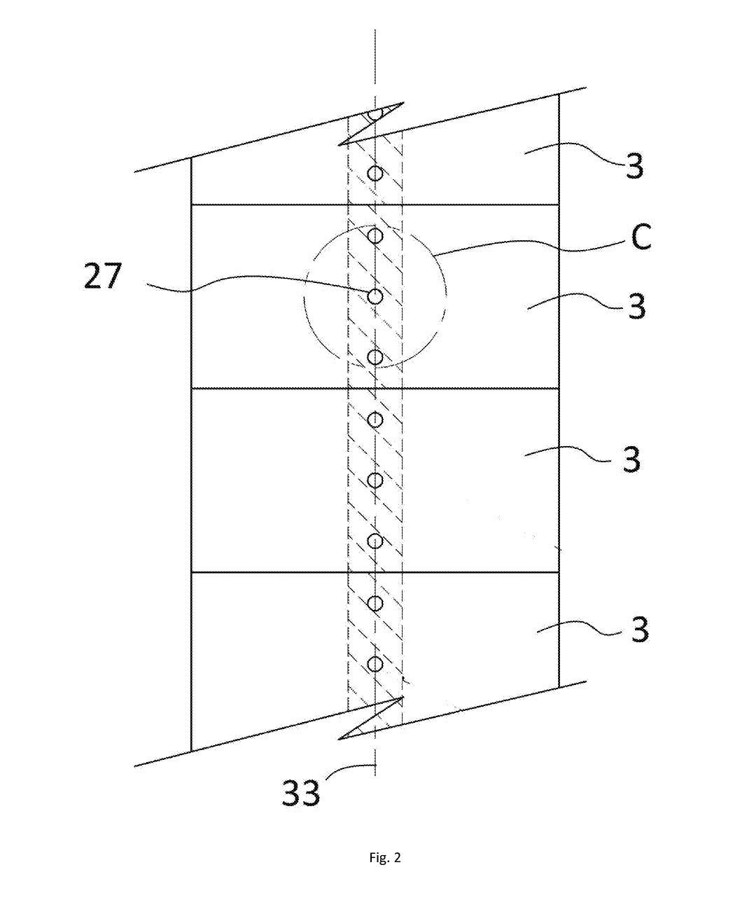

Referring to FIG. 1 and FIG. 2, multiple LED modules 3 are mounted side-by-side along the length of the print curing apparatus 1. The arrangement of LEDs 5 in each module 3 and the grouping of the multiple LED modules 3 in an array is configured according to the print effect to be achieved by the UV print curing apparatus 1. For example, each LED module 3 includes a plurality of LEDs 5 grouped across a central portion of the LED module 3 such that when a plurality of LED modules 3 are placed and secured side-by-side, a continuous line of LEDs 5 is provided along the length of the array and so the length of the UV print curing apparatus 1. The length of the LEDs 5 along the apparatus 1 can be increased or decreased according to the substrate to be cured.

Referring to FIG. 1, each LED module 3 is secured to the lower housing 9a of the apparatus 1 by a pair of pins 11 and the head of each pin 11 is held in electrical contact with the conductive surface of the LED module 3. Each pin 11 engages with a conductive surface 15 on the LED module 3 and the pin 11 is connectable to a power supply (not shown) for providing power to the conductive surface 15. Each pin 11 further comprises a tubular electrical insulating sleeve 17, which prevents contact, and so conduction, between the pin 11, the LED module 3 and the body 9. The UV print curing apparatus 1 is also provided with an upper casing 9b enclosing the pairs of pins 11 and a jet cooling system 19. The mounting arrangement shown in FIG. 1 is given by way of example only and it is understood that there are alternative mounting arrangements for the or each LED module.

The jet cooling system 19 uses a cooling fluid; for example, air or water to carry heat away from the heat sink 4 and so from the LED modules 3.

The UV print curing apparatus 1 further comprises a cover or base-member 21 provided by two opposing, co-planar cover plates 21. Each plate 21 overlaps one of the two opposing ends of the LED module 3 with a curing aperture 23 formed therebetween. Light emitted from the LEDs 5 can exit through this curing aperture 23. A transparent window 25 is slideably mounted across the curing aperture 23 between the plates 21 and is positioned in use between the LED modules 3 and the substrate (not shown) that is to be cured. The transparent window 25 comprises multiple segments and comprises a material such as quartz or glass.

Referring to FIGS. 1 and 2, it is shown that the cooling effect of the jet cooling system 19 is matched to the heat intensity profile across the LED modules 3 and so, along the length of the apparatus 1. The cooling effect achieved by the present invention is substantially uniform along the length of the UV print curing apparatus 1.

It is to be understood that “substantially” refers to the cooling effect and so the temperature of the LED modules is understood to be substantially uniform along the length of the print curing apparatus; i.e. preferably, the temperature varies by less than about ±30% along the length of the print curing apparatus; more preferably, the temperature varies by less than about ±20% along the length of the apparatus; still more preferably, the temperature varies by less than about ±10% along the length of the print curing apparatus.

Referring to FIGS. 1, 2 and 3, in a first embodiment of the jet cooling system 19, water jets 29 having a diameter of about 1 to about 3 mm enter the system through apertures 27 positioned along the length of the ink curing apparatus 1. The direction of each of the plurality of water jets is substantially perpendicular to the heat sink towards which they are directed.

It is envisaged that, in alternative embodiments of the present invention, the apertures are replaced with nozzles through which fluid is directed and/or the direction of each of the plurality of water jets is angled towards the heat sink. For example, the shape and configuration of the or each aperture or nozzle can be configured to direct the or each water jet at an angle of between about 20 and about 80 degrees; preferably, at an angle of between about 40 and about 60 degrees to an axis perpendicular to the plane of the heat sink. In any of these embodiments, the fluid pressure behind the aperture or nozzle 27, i.e. before the fluid jet is directed towards the heat sink, of the jet cooling system 19 is greater than the fluid pressure in front of the aperture or nozzle 27, i.e. where the fluid is directed towards the heat sink 4. This pressure difference ensures that the cooling effect of the fluid jets 29 is uniform regardless of the length of the lamp head. In a preferred embodiment of the present invention, the pressure difference between the fluid behind the aperture and the fluid in front of the aperture is at least about 0.3 Bar. It has been found that the pressure difference needs to be carefully balanced between having a pressure difference that is too low, which will reduce the efficiency of cooling and a pressure difference that is too high, which will increase the efficiency of cooling but will also increase the likelihood of erosion of the heat sink and the cost and complexity of maintaining high pressure pumping equipment.

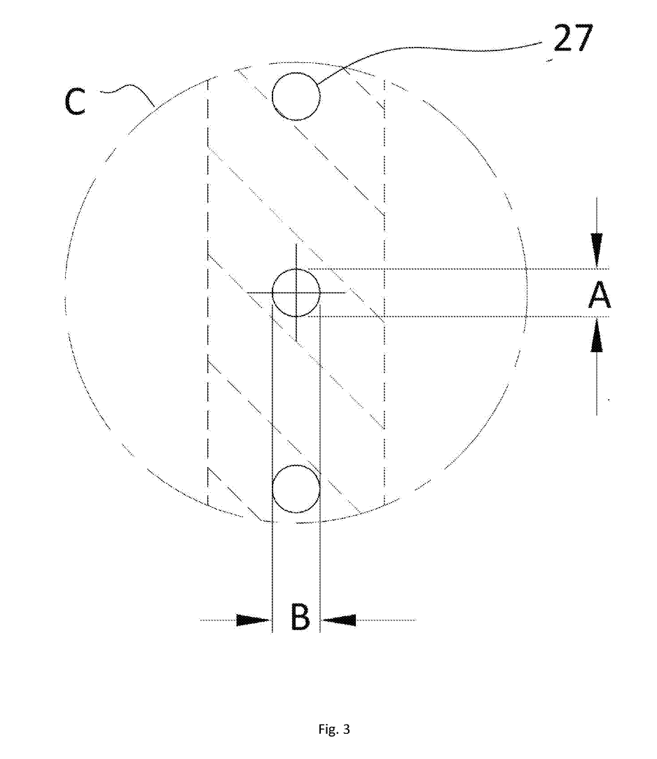

Referring to FIG. 2 and FIG. 3, the apertures 27 are arranged along the centre line 33 of the LED array and are substantially equidistant along the length of the array. Referring to the enlarged area C in FIGS. 2 and 3, each aperture is substantially circular having a diameter of between about 1 and about 3 mm. The water jets 29 enter the jet cooling system to create a turbulent flow of fluid, as indicated by arrows 29 in FIG. 1.

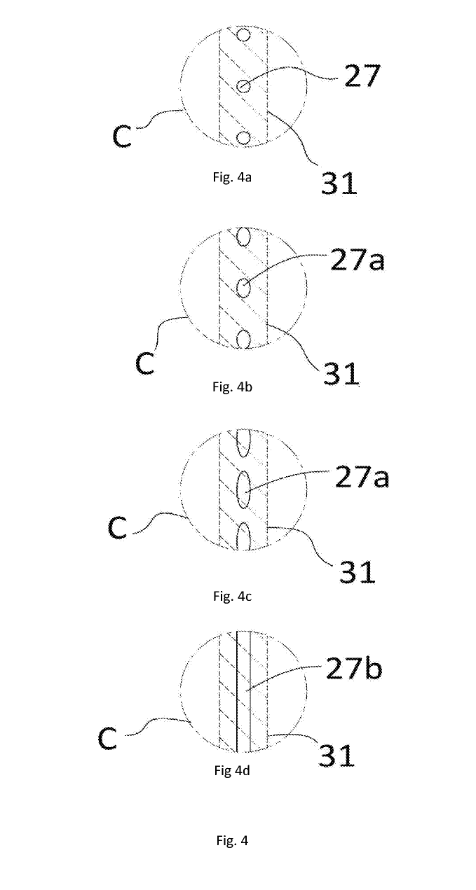

Referring to FIG. 4, it is envisaged that in alternative embodiments of the present invention the apertures 27 through which fluid enters the jet cooling system are elliptical 27a, as shown in FIGS. 4b and 4c; or comprises a continuous slot 27b, as shown in FIG. 4d. The circumference of each aperture is best described by Equation 1, wherein A is a first axis of the aperture; B is a second axis of the aperture; x is the distance along the width of the LED head and y is the distance along an axis perpendicular to the width of the LED head:

$$\frac{4 {x}^{2}}{{A}^{2}} + \frac{4 {y}^{2}}{{B}^{2}} = 1 \qquad [ Equation 1 ]$$

Referring to Equation 1 and FIGS. 4b and 4c, as A increases then the major axis of the ellipse A becomes greater than the minor axis of the ellipse B. As A increases still further, the aperture becomes an elongate slot along the centreline of the LED modules, as shown in FIG. 4d.

Fluid jets entering the ink curing apparatus through the apertures 27, 27a or a suitably configured slot 27b ensure that the possibility for the creation of a laminar flow of fluid is avoided.

The present invention provides superior heat transfer from the rear/upper face 4a of the heat sink 4, and so superior cooling of the LED modules 3 is achieved. It is to be understood that the rear/upper face of the heat sink 4b refers to the orientation of the ink curing apparatus 1 in use; whereby the upper face 4b is the face of the heat sink 4 furthest from the substrate to be cured. The jets of fluid 29 prevent the creation of a laminar fluid flow around the cooling system 19. It has been found that creation of a laminar fluid flow leads to “boundary layers” of fluid forming adjacent/parallel to the surface of the heat sink 4. These fluid layers do not move sufficiently rapidly to carry heat away from the heat sink 4, but cause heat to be retained along the boundary of the fluid with the heat sink 4. The water jets of the preferred embodiment of the present invention, having a diameter of between about 1 and about 3 mm, ensure that the flow is sufficiently turbulent to avoid creation of any heat-retaining boundary layers of fluid.

With reference to FIG. 1, the fluid enters the cooling system 19 through the apertures 27 and is incident on the rear face of the heat sink 4. Heat passing from the LED module 3 to the heat sink 4 is carried away from the heat sink 4 upwardly through the cooling system by the fluid 29 flowing out of the cooling system 19.

With reference to FIG. 2, the turbulent fluid flow ensures that heat is rapidly and efficiently removed from the upper/rear face of the heat sink 4. Furthermore, the fluid jets of the present invention, which enter the cooling system 19 at a pressure in the range of between about 1.5 Bar and about 10 Bar, create a turbulent flow whilst ensuring that the fluid cooling system 19 is suited to a wide range of lengths of ink curing apparatus, without requiring a significantly larger diameter of fluid inlet tubes. The cooling system 19 of the present invention is part of a closed loop cooling system whereby an external refrigeration/chiller unit positioned at the rear of the ink curing apparatus 1 allows fluid to be cooled and re-used.

Each LED module 3 is mounted on a heat sink 4 onto which fluid jets are directed. In the embodiment shown in FIG. 2, fluid jets are directed through three circular apertures 27 per LED module 3. The circular apertures are positioned along a water channel 31. Each circular aperture 27 is positioned equidistant from the adjacent LED module 3 along the longitudinal midline of the LED board on which the LED module 3 is mounted. Thus, the cooling fluid is focussed substantially along the centre of the LED module 3; that is, to coincide with the hottest region of the LED array. This arrangement is replicated for each LED module 3 and associated heat sink 4. In this way, the cooling is substantially uniform for each of the LED modules 3 in the array of the ink curing apparatus 1, such that the cooling effect achieved is independent of the length of the apparatus 1.

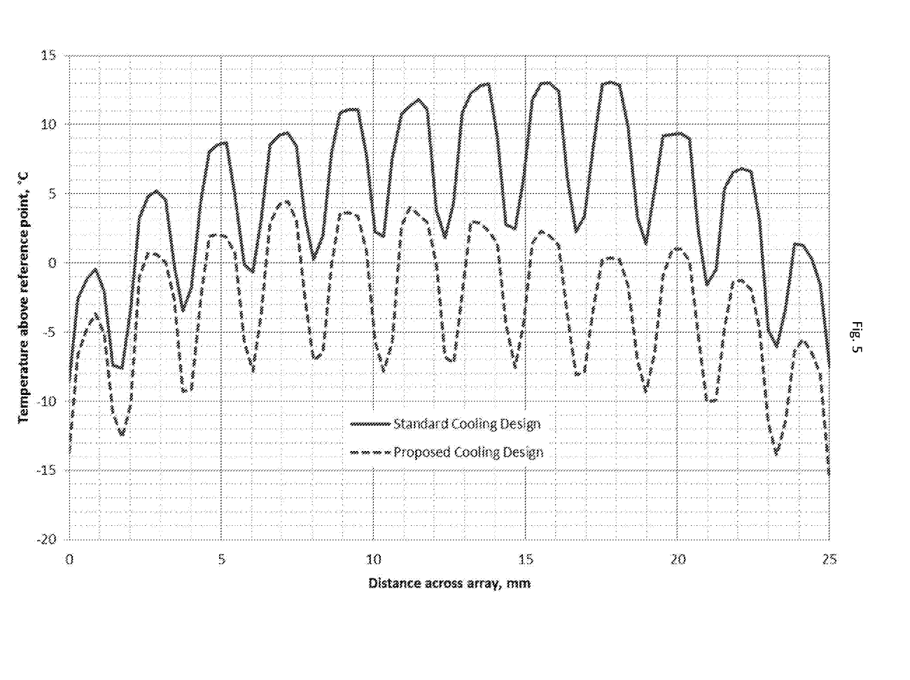

Referring to FIGS. 1 and 5, the cooling system 19 and cooling method of the present invention ensures that the water flow rate and the cooling effect at the n^{th} LED module 3 is the same as the water cooling of the LED module 3 closest to the water inlet. As shown in FIG. 5, the improved cooling effect achieved by the present invention is substantially uniform across the full length of the apparatus; i.e. along the full length of the array comprising multiple LED modules. This is achieved by keeping the cross-sectional area of the sum of the jet holes smaller than the cross-sectional area of the inlet pipe. The water inlet to the ink curing apparatus 1 is insulated from the heat sink 4 by the return water, i.e. the water exiting the ink curing apparatus 1. The inlet of water is insulated until the water is forced through the apertures 27 to form the fluid jets 29, which enter the apparatus 1. This arrangement ensures that the inlet water temperature at the n^{th} LED module 3 is substantially the same as the water temperature at the first LED module 3.

In an alternative embodiment of the present invention, the fluid used for cooling is air. The air enters the cooling system in the same way as described above with respect to a water cooled system. The air may be drawn into the system through circular or elliptical apertures, or through slots. Air is drawn or propelled into the cooling system through the apertures. As described above in respect of a water cooled system, air is drawn into the system near to the rear face of the heat sink and carries heat away from the LED modules. The air is drawn into the cooling system using a fan and the system is configured so that a turbulent air flow is created and the flow rate is uniform regardless of the length of the ink curing apparatus 1.

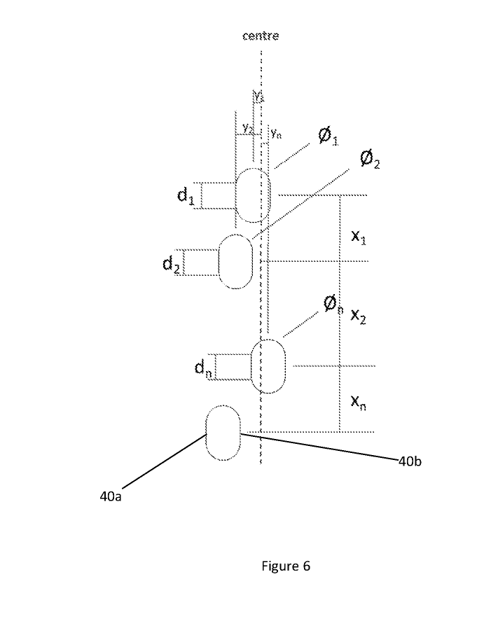

Referring to FIG. 6, in a further embodiment of the present invention the apertures 40 through which the or each fluid jet is directed comprise a generally elliptical shape; i.e. a closed curved shape, but also have two opposing straight sides 40a and 40b, each having a length d and a curved radius of Ø. FIG. 6 illustrates that as dₙ→0 then the aperture tends to a circular shape having a radius of Ø. FIG. 6 shows the separation of each aperture to be x and the distance from the midline of the heat sink to be y.

If dₙ=0 then the apertures comprise holes of radius Øₙ separated from each other by distance xₙ along the longitudinal direction, that is along the length or longest dimension of the heat sink, and separated from the midline of the heat sink by a distance yₙ. It is envisaged that in alternative embodiments of the present invention, the distance xₙ varies along the length of the heat sink, i.e. the apertures are not equally spaced and/or the distance yₙ varies along the length of the heat sink, i.e. the apertures are not equally spaced from the midline.

If dₙ>0 then the apertures tend to be longer elliptical slots, again separated from the adjacent aperture by distance xₙ in the longitudinal direction (along the length or longest dimension of the heat sink) and separated from the midline of the heat sink by a distance yₙ. The present applicant has established that the most preferred arrangement of the apertures of the present invention, to direct a plurality of fluid jets towards the or each heat sink is as described below:

d₁=d₂=dₙ=0

y₁=y₂=yₙ=0

1 mm<Ø₁=Ø₂=Øₙ<3 mm

6 mm<x₁=x₂=xₙ<10 mm

Thus, it was found that to achieve the required uniform cooling it is preferred to have a plurality of circular apertures having a radius of between about 1 mm and about 3 mm, wherein the centres of each circular aperture are separate from adjacent aperture/s by a longitudinal distance of between about 6 mm and about 10 mm. For the most efficient and uniform cooling, it is preferred that the centre of the or each aperture is positioned along the longitudinal midline of the heat sink; that is, each aperture is centrally positioned with respect to the length of the heat sink. It is understood that the length of the heat sink is intended to refer to the longest dimension of the heat sink, which is generally rectangular.

With reference to FIG. 1, it has also been found that to achieve the required uniform cooling along the heat sink, the spacing between the aperture or nozzle 27 through which the or each fluid jet is directed is between about 3 mm and about 5 mm. This distance ensures that the water jets have sufficient speed to create a turbulent flow when they hit the heat sink.

Within this specification, the term “about” is understood to mean plus or minus 20%, more preferably plus or minus 10%, even more preferably plus or minus 5%, most preferably plus or minus 2%.

The above described embodiment has been given by way of example only, and the skilled reader will naturally appreciate that many variations could be made thereto without departing from the scope of the claims.

1. A print curing apparatus, comprising:
one or more LED modules wherein each LED module comprises at least one LED and wherein each LED module is mounted on a heat sink; and
a cooling system having one or more fluid jets wherein each fluid jet is directed towards each heat sink.

2. A print curing apparatus according to claim 1, wherein each fluid jet is expelled from an aperture.

3. A print curing apparatus according to claim 2, wherein the aperture is spaced from the heat sink.

4. A print curing apparatus according to claim 1, wherein the fluid is air or water.

5. A print curing apparatus according to claim 1, wherein each fluid jet has a diameter of between about 0.5 mm to about 5 mm.

6. A print curing apparatus according to claim 1, wherein each fluid jet enters the cooling system through an aperture.

7. A print curing apparatus according to claim 6, wherein r each aperture has a diameter of between about 0.5 mm to about 5 mm.

8. A print curing apparatus according to claim 1, wherein each heat sink is formed of metal.

9. A print curing apparatus according to claim 1 wherein the cooling system comprises a plurality of fluid jets, and wherein each of said plurality of fluid jets is directed towards the heat sink in a direction substantially perpendicular to the planar surface of the heat sink.

10. A print curing apparatus according to claim 1, wherein the cooling system is configured such that the flow of fluid is turbulent.

11. A print curing apparatus according to claim 1, wherein the flow of fluid around the cooling system is at a rate of between about 0.25 L/min to about 10.00 L/min per 2.5 cm width of an array comprising one or more LED modules.

12. A print curing apparatus according to claim 1, wherein the flow of fluid around the cooling system is at a rate of between about 0.1 to about 5.0 L/min per cm width of an array comprising one or more LED modules.
